(19) United States
(12) Patent Application Publication
(10) Pub. No.: US 2007/0242240 A1
(43) Pub. Date: Oct. 18, 2007

(54) SYSTEM AND METHOD FOR MULTI-PROJECTOR RENDERING OF DECODED VIDEO DATA

(75) Inventors: Stephen B. Webb, Louisville, KY (US); Christopher O. Jaynes, Lexington, KY (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: MERSIVE TECHNOLOGIES, INC., Lexington, KY (US)

(21) Appl. No.: 11/735,258

(22) Filed: Apr. 13, 2007

Related U.S. Application Data
(60) Provisional application No. 60/744,799, filed on Apr. 13, 2006.

(51) Int. Cl. G03B 21/00

(52) U.S. Cl. 353/121

(57) ABSTRACT

The present invention relates to multi-projector image rendering systems and methods for their operation. According to the present invention, a plurality of image projectors are coupled to an image processor and the system utilizes specialized image processing methodology to render an output image that is composed of pixels collectively rendered from the plural image projectors. As a result, the resolution of the rendered video can exceed the video resolution that would be available from a single projector.

### CROSS-REFERENCE TO RELATED APPLICATIONS

This application claims the benefit of U.S. Provisional Application Ser. No. 60/744,799 (MES 0002 MA), filed Apr. 13, 2006.

This application is related to commonly assigned, copending U.S. patent application Ser. No. ______ (MES 0001 PA), filed ______, and Ser. No. ______ (MES 0009 PA), filed ______, the disclosures of which are incorporated herein by reference.

### BRIEF SUMMARY OF THE INVENTION

The present invention relates to multi-projector image rendering systems and methods for their operation. According to the present invention, a plurality of image projectors are coupled to an image processor and the system is operated to render an output image that is composed of pixels collectively rendered from the plural image projectors. As a result, the resolution of the rendered video can exceed the video resolution that would be available from a single projector.

In accordance with one embodiment of the present invention, a method of operating a multi-projector image rendering system is provided. According to the method, an input video stream is converted into a sequence of relatively static images and the static images are decomposed into respective sets of sub-images. The resolution of each sub-image is lower than the resolution of each static image because the sub-images descend from the original static image. Further, sets of sub-images sets collectively represent the input video stream because the sub-image sets descend from the input video stream.

The decomposed sub-images are converted to sub-image video blocks that represent respective spatial regions of the input video stream. Video block subscriptions are identified for each of the image projectors and the image projectors are operated to project image data corresponding to the identified video block subscriptions. In this manner, the image projectors collectively render a multi-projector image representing to the input video stream. It is contemplated that the aforementioned image rendering steps may be performed in sequence, simultaneously, or otherwise.

Additional embodiments of the present invention are contemplated including, but not limited to, those where an image rendering system is programmed to automatically execute the aforementioned image rendering methodology. Accordingly, it is an object of the present invention to provide improved systems and methods of rendering relatively high resolution images with multiple image projectors. Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is a schematic illustration of a multi-projector image rendering system according to one embodiment of the present invention;

FIG. 2 is a schematic illustration of the manner in which a multi-projector image rendering system according to one embodiment of the present invention processes image data for rendering via multiple image projectors; and

FIG. 3 is a flow chart illustrating a method of operating a multi-projector image rendering system according to one embodiment of the present invention.

### DETAILED DESCRIPTION

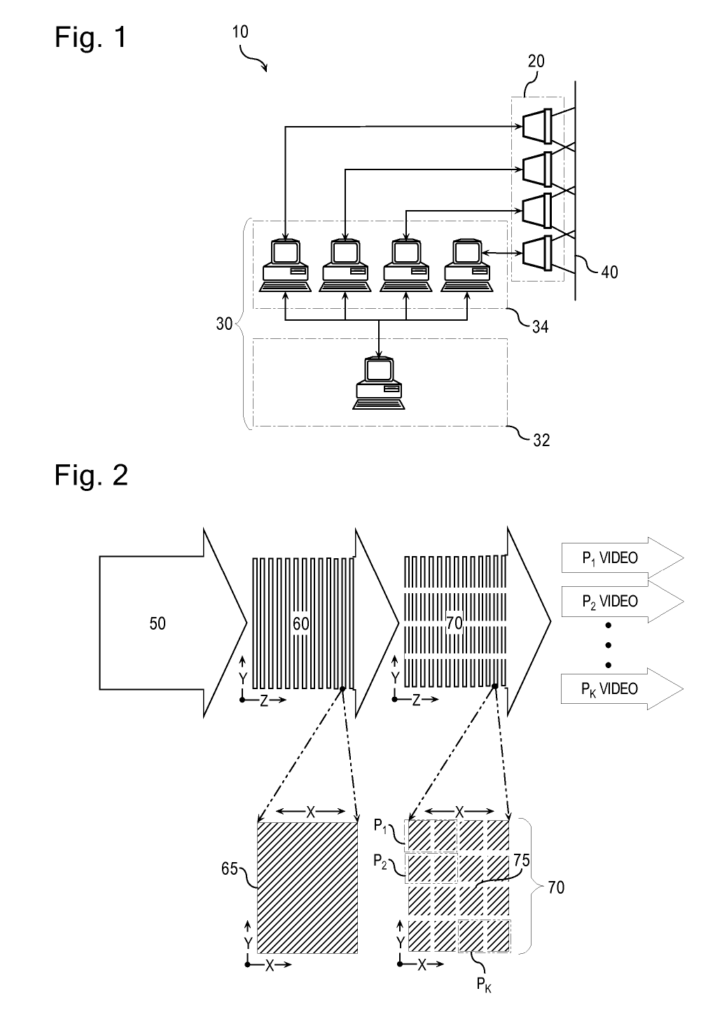

A multi-projector image rendering system 10 configured according to one specific embodiment of the present invention is presented in FIG. 1 to illustrate particular aspects of the present invention. In FIG. 1, the multi-projector image rendering system 10 comprises a plurality of image projectors 20 coupled to an image processor 30. The image processor 30 comprises a video stream processing component 32 and a video display component 34. Suitable communication links are provided to place the components of the image processor 30 in communication with each other and with the image projectors 20.

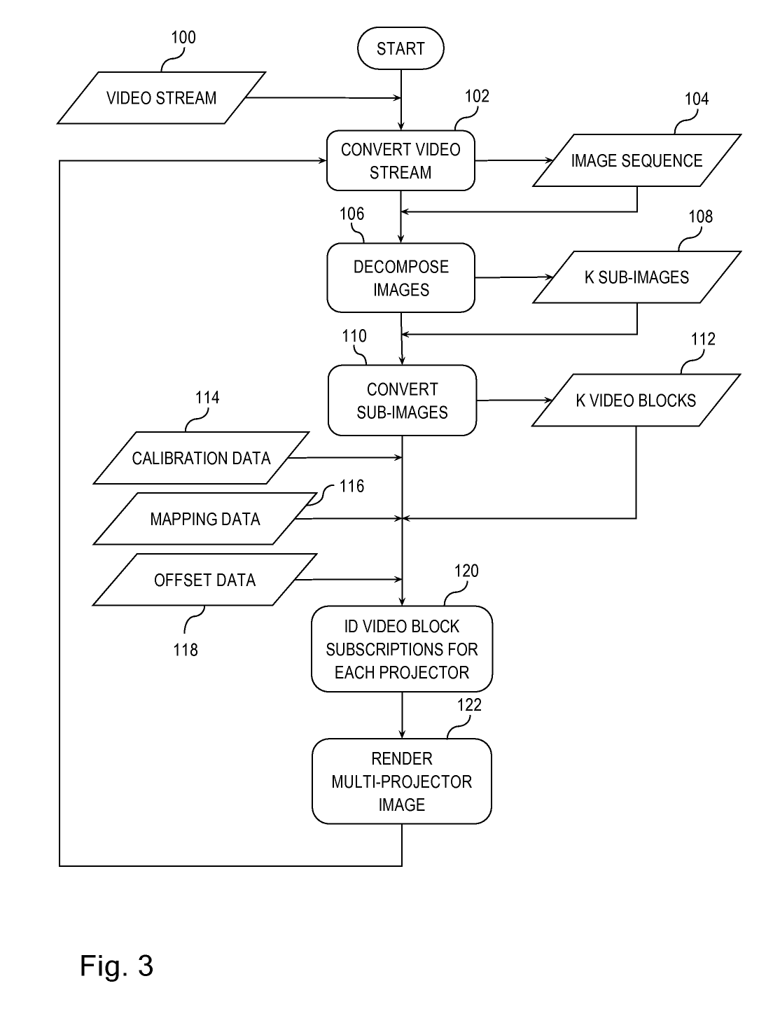

Referring additionally to FIGS. 2 and 3, in operation, the image processor 30 converts an input video stream 50 into a sequence 60 of images 65 that are relatively static when compared to the dynamic input video stream (see blocks 100, 102). These relatively static images 65 are decomposed into respective sets 70 of sub-images 75 (see blocks 104, 106) such that each sub-image set 70 comprises a set of k sub-images 75. Typically, the static images are decomposed into respective sets of sub-images 75 that collectively contain the complete set of data comprised within the input video stream 50.

The decomposed sub-images 75 are converted to into k independently encoded sub-image video blocks P₁, P₂, P_{K}, each representing respective spatial regions of the input video stream 50 (see blocks 108, 110, 112). More specifically, each of the k sub-image video blocks P₁, P₂, P_{K} will correspond to one or more of the k spatial regions of the static images. As is illustrated in FIG. 2, the resolution of each sub-image 75 is lower than the resolution of each static image 65 and the sub-image sets 70 collectively represent the input video stream 50. It is contemplated that the sub-image video blocks P₁, P₂, P_{K} can represent overlapping or non-overlapping spatial regions of the input video stream. It is further contemplated that it may not always be preferable to encode the sub-image video blocks P₁, P₂, P_{K} independently, particularly where completely independent encoding would result in artifacts in the rendered image. For example, block edge artifacts in the recomposed image may be perceptible if MPEG encoding used. It may be preferable to read some information from neighboring image blocks during the encoding process if these types of artifacts are likely to be an issue.

To render a multi-projector image 40, video block subscriptions are identified for each of the image projectors 20 and the image projectors 20 are operated to project image data corresponding to the identified video block subscriptions (see blocks 120, 122). For example, the video block subscriptions for each of the image projectors 20 can be identified by matching a frustum of each image projector 20 with pixels of the sub-image video blocks. Alternatively, a pixelwise adjacency table representing all of the projectors can be used to determine which video blocks should be identified for construction of the respective video block subscriptions. In either case, the image projectors 20 will collectively render the multi-projector image 40 such that it represents the input video stream.

To facilitate enhanced image projection, the frustum of each image projector 20 is determined by referring to the calibration data for each image projector (see block 114). Although it is contemplated that the calibration data for each image projector 20 may take a variety of conventional or yet to be developed forms, in one embodiment of the present invention, the calibration data comprises a representation of the shape and position of the vertex defining the view frustum of the image projector of interest, relative to the other image projectors within the system. The projector frustum of each image projector 20 can also be defined such that it is a function of a mapping from a virtual frame associated with each image projector 20 to a video frame of the rendered image 40. Typically, this type of mapping defines the manner in which pixels in the virtual frame translate into spatial positions in the rendered image 40. Finally, it is contemplated that the frustum of each image projector 20 can be matched with pixels of the sub-image video blocks P₁, P₂, P_{K} by accounting for spatial offsets of each sub-image video block in the rendered image 40 and by calibrating the image projectors 20 relative to each other in a global coordinate system.

For example, consider a multi-projector video display in which two host computers are connected to two projectors mounted side-by-side to produce a double-wide display. The left projector and host computer do not require data that will be displayed by the right host computer and right projector. Accordingly, once the original data has been encoded into a set of video blocks, only the video blocks required by the particular host computer projector pair are decoded. For the left projector, only the sub-image blocks from the left half of the original input image sequence are required. Similarly, for the right projector, only the sub-image blocks from the left half of the original image sequence are required. In this manner, computational and bandwidth costs can be distributed across the display as more computers/projectors are added to increase pixel count.

Typically, a computer/projector determines which sub-image blocks are required by computing whether the projector frustum overlaps with any of the pixels in the full-resolution rendered image 40 contained in a given video block. Several pieces of information are required in order to compute the appropriate video block subscriptions for each image projector. Referring to the example of the left/right projector configuration above, the left projector/computer pair must be able to know the shape and position of each vertex describing its view frustum with respect to the right projector. The relative position of the different projector frame buffers define a space that can be referred to as the virtual frame buffer as it defines a frame buffer (not necessarily rectangular) that can be larger than the frame buffer of any individual computer/projector. Secondly, a mapping from the video frame to the virtual frame buffer must be known. This mapping can be referred to as the movie map and designates how pixels in the virtual frame buffer map to positions in the full movie frame. Finally, the offsets of each block in the full move frame must be known. Given this information, each projected frustum, and the corresponding computer that generates images for that projector, can subscribe to video blocks that overlap with that projector's frustum.

As is noted above, the image processor 30 comprises a video stream processing component 32 and a video display component 34. Typically, the video stream processing component 32 comprises a host computer and the video display component 34 includes parallel image projection hardware, e.g., a set of programmable computers, in communication with the video stream processing component 32. The set of programmable computers forming the video display component 34 are used to operate the image projectors by processing distinct video block subscriptions identified for each of the image projectors. Although the illustrated embodiment shows a set of programmable computers linked to a host computer, it is contemplated that the functionality of the set of programmable computers may be incorporated in a single programmable computer or into the single host computer. For example, the single host computer may contain several graphics cards and associated processing circuitry, each capable of operating the image projectors by processing the distinct video block subscriptions identified for each of the image projectors.

As is noted above, to render an image, the set of video blocks required by a particular projector must be decoded and rendered into the projector frame buffer. Suitable software for executing this operation may reside in the host computer of the video stream processing component 32 or in the individual computers forming the video display component 34. Further, the video stream processing component 32 and the video display component 34 can be arranged to synchronize projection of the video block subscriptions in the rendered image.

More specifically, once the decomposed sub-images 75 are converted to into k independently encoded sub-image video blocks P₁, P₂, P_{K}, each representing respective spatial regions of the input video stream 50, the respective video blocks are ready for transmission to the video display component 34 of the image processor 30. Generally, the transmission of the video blocks can be initiated by the video stream processing component 32, the video display component 34, or some combination thereof. When initiated by the video display component 34, software residing on the hardware of the respective parallel sub-components of the video display component 34 determines which sub-image sequence(s) are required in order to generate and display the correct portion of the video sequence. Once this is determined, the video display component 34 requests the sub-image sequence(s) from storage and transmission hardware residing on the video stream processing component 32. It is contemplated that this could be accomplished in a variety of conventional or yet to be developed ways including, but not limited to, configurations comprising TCP/IP socket connections and basic protocol or a shared or networked file system. When the video display component 34 receives the appropriate video block files, they can be stored locally in permanent storage, or temporarily until video decoding and playback has been accomplished. If a copy is stored locally, subsequent playback does not require re-transmission of the original sub-image sequences unless the sub-image sequences have changed.

When transmission of the video blocks is initiated by the video stream processing component 32, software residing therein can be configured to choose to accept, not accept, or otherwise select the transmission of a particular sub-image sequence, depending at least in part on the projector's geometric calibration. According to one contemplated embodiment of the present invention, this operation could be carried out by configuring the video stream processing component 32 to create one UDP/multicast channel for each sub-image sequence. In which case, the video display component 34 would determine which sub-image sequences are required, and subscribe to the corresponding multicast channels. In this way, the receiving hardware would receive and process only the sub-image sequences that are required, and ignore the other sub-image sequences.

Because the present invention relates to multi-projector displays where the sub-image video blocks P₁, P₂, P_{K} can represent overlapping spatial regions of the input video stream, it may be preferable to configure the video stream processing component 32, the video display component 34, or both, to blend overlapping portions of the video block subscriptions in the rendered image. The specific manner in which video block blending is executed is beyond the scope of the present invention and may be gleaned from conventional or yet-to-be developed technology, an example of which is presented in the above-noted copending application—Ser. No. ______ (MES 0001 PA), filed ______. It is contemplated that the video stream processing component 32, the video display component 34, or both, can be configured to manipulate image data carried by the video block subscriptions to enhance or otherwise alter the rendered image.

Referring to FIG. 2, in one specific embodiment of the present invention, the input video stream 50 comprises a sequence of rectangular digital images, e.g., a sequence of JPEG images, an MPEG-2 video file, an HDTV-1080p broadcast transmission, or some other data format that can be readily decoded or interpreted as such. The input video sequence 50 is processed and decoded to the point where it can be spatially segmented into sub-image video blocks P₁, P₂, P_{K}. In the case of JPEG images, for example, the images could be partially decoded to the macroblock level, which would be sufficient to spatially segment the image.

Once the image sequence 60 has been decoded to raw image data, the video stream processor segments each image in the sequence to generate the respective sets 70 of sub-images 75. In the embodiment at hand, the segmentation step decomposes each image into a set of rectangular sub-images. In the most straightforward form, the sub-images are all the same size, and do not overlap each other. For example, an input image with resolution 1024×768 pixels could be divided into 4 columns and 3 rows of 256×256 sub-images, giving 12 non-overlapping sub-images. Note that it is not required that each sub-image be the same resolution, nor is it required that the sub-images do not overlap with one another. The only requirement is that the original image can be completely reproduced from the set of sub-images and that the segmentation geometry remain the same for all images in the input image sequence. The result of the processing step is a collection of sub-image sequences that, taken together, fully represent the input image sequence. This collection of sub-image sequences may be encoded to the original (input image) format, or to some other format. For example, a sequence of 1024×768 JPEG images, after processing, may be represented as 12 256×256 JPEG image sequences, or 12 256×256 MPEG-2 encoded video sequences.

The next step is the storage and transmission of the processed video stream, which is handled by the image processor 30. First, each of the processed sub-image sequences are saved to permanent storage such as a computer hard disk. The sub-image sequences are stored together, along with additional data describing the format and structure of the sub-image sequences. This additional data helps re-create the original image sequence from the sub-image sequences. These may be stored together in a database, as a single file, or as a collection of individual files, as long as each sub-image sequence can be retrieved independently and efficiently. As is noted above, the sub-image video blocks P₁, P₂, P_{K} can be transmitted to the image projectors after permanent storage of the processed video stream is complete.

In many cases, it may be necessary to utilize additional software components, e.g., MPEG-2 decoding library software, to decode the sub-image video blocks P₁, P₂, P_{K} prior to projection depending, at least in part, on the format of the sub-image sequences. The correct image can be generated from the decoded sub-image sequences based on the geometric calibration of the projector, i.e., the correspondence between pixels in a given projector and the pixels of the original input video stream. By using this geometric calibration, the image rendering software determines which sub-image sequences contain data relevant to a given projector. Once the relevant sub-image sequences have been retrieved and decoded, a geometrically correct image is generated and displayed. The image is geometrically correct in the sense that the final projected image 40 contains the corresponding pixels of the original input image as described by the geometric calibration. The geometric calibration system can be designed so that the resulting composite image, as displayed from multiple projectors, generates a single geometrically consistent image on the display surface.

In addition to the decoding and geometric correction of the sub-image sequences, the video decoding and display software residing in the image processor 30 can be configured to communicate with centralized synchronization software residing in the image processor 30, in order to ensure temporally consistent playback among all instances of the video decoding and display software. Other contemplated methods of synchronization involve direct communication between the image processors. For example, the image processors could collectively broadcast a “Ready” signal to all other image processors and when each image processor has received a predetermined number of “Ready” signals, the frame would be displayed.

Although the operation of the image rendering systems of the present invention have generally been described as independent sub-processes happening in sequence, it may be preferable to run some or all of the processes simultaneously. For example, if the input image sequence is a broadcast video feed, it would be desirable to process, distribute and display the incoming video stream simultaneously. In such a configuration, certain steps would be restricted or bypassed. For example the permanent storage to disk may not be desirable, and instead the encoded sub-image sequences, or parts thereof, could be transmitted via the network. Aside from some buffering and transmission overhead, the video stream would be processed, transmitted and displayed simultaneously, as it is received from the broadcast source.

For the purposes of describing and defining the present invention, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of a component of the present invention being “programmed” in a particular way, “configured” or “programmed” to embody a particular property or function in a particular manner, are structural recitations as opposed to recitations of intended use. More specifically, the references herein to the manner in which a component is “programmed” or “configured” denotes an existing physical condition of the component and, as such, is to be taken as a definite recitation of the structural characteristics of the component.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue. The term “substantially” is further utilized herein to represent a minimum degree to which a quantitative representation must vary from a stated reference to yield the recited functionality of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A method of operating a multi-projector image rendering system comprising a plurality of image projectors coupled to an image processor, the method comprising:
converting an input video stream into a sequence of relatively static images;
decomposing the relatively static images into respective sets of sub-images, wherein the resolution of each sub-image is lower than the resolution of each static image and the sub-image sets collectively represent the input video stream;
converting the decomposed sub-images to sub-image video blocks representing respective spatial regions of the input video stream;
identifying video block subscriptions for each of the image projectors; and
operating the image projectors to project image data corresponding to the identified video block subscriptions such that the image projectors collectively render a multi-projector image representing the input video stream.

2. A method of operating a multi-projector image rendering system as claimed in claim 1 wherein the static images are decomposed into respective sets of sub-images that collectively contain the complete set of data comprised within the input video stream.

3. A method of operating a multi-projector image rendering system as claimed in claim 1 wherein each static image is decomposed into a plurality of sets of sub-images, each representing overlapping or non-overlapping spatial regions of the static image.

4. A method of operating a multi-projector image rendering system as claimed in claim 1 wherein the decomposed sub-images are converted into independently encoded sub-image video blocks, each representing overlapping or non-overlapping spatial regions of the input video stream.

5. A method of operating a multi-projector image rendering system as claimed in claim 1 wherein each static image is decomposed into a plurality of sets of k sub-images, each representing overlapping or non-overlapping spatial regions of the static image and the decomposed sub-images are converted into k independently encoded sub-image video blocks, each corresponding to one of the k spatial regions of the static images.

6. A method of operating a multi-projector image rendering system as claimed in claim 1 wherein the video block subscriptions for each of the image projectors are identified by mapping from a virtual frame associated with each image projector to a video frame of the rendered image such that the mapping defines the manner in which pixels in the virtual frame translate into spatial positions in the rendered image.

7. A method of operating a multi-projector image rendering system as claimed in claim 6 wherein calibration data for each image projector comprises a representation of the shape and position of the vertex defining the view frustum of the image projector relative to other image projectors within the system.

8. A method of operating a multi-projector image rendering system as claimed in claim 1 wherein:
the video block subscriptions for each of the image projectors are identified by matching a frustum of each image projector with pixels of the sub-image video blocks; and
the projector frustum of each image projector is a function of a mapping from a virtual frame associated with each image projector to a video frame of the rendered image.

9. A method of operating a multi-projector image rendering system as claimed in claim 8 wherein the mapping defines the manner in which pixels in the virtual frame translate into spatial positions in the rendered image.

10. A method of operating a multi-projector image rendering system as claimed in claim 1 wherein:
the video block subscriptions for each of the image projectors are identified by matching a frustum of each image projector with pixels of the sub-image video blocks; and
the frustum of each image projector is matched with pixels of the sub-image video blocks by accounting for spatial offsets of each sub-image video block in the rendered image.

11. A method of operating a multi-projector image rendering system as claimed in claim 1 wherein the image projectors are calibrated relative to each other in a global coordinate system.

12. A method of operating a multi-projector image rendering system as claimed in claim 1 wherein:
the image processor comprises a video stream processing component and a video display component; and
software for identifying the video block subscriptions for each of the image projectors resides on the video stream processing component, the video display component, or both.

13. A method of operating a multi-projector image rendering system as claimed in claim 1 wherein:
the image processor comprises a video stream processing component and a video display component;
the video display component includes parallel image projection hardware in communication with the video stream processing component; and
the parallel components of the image projection hardware are used to operate the image projectors by processing distinct video block subscriptions identified for each of the image projectors.

14. A method of operating a multi-projector image rendering system as claimed in claim 1 wherein:
the image processor comprises a video stream processing component and a video display component; and
the video stream processing component comprises storage for the sub-image video blocks and the image data corresponding to the identified video block subscriptions is projected by accessing the video block storage.

15. A method of operating a multi-projector image rendering system as claimed in claim 1 wherein:
the image processor comprises a video stream processing component and a video display component; and
the video stream processing component is used to convert the input video stream, decompose the static images, and convert the decomposed sub-images.

16. A method of operating a multi-projector image rendering system as claimed in claim 15 wherein the video stream processing component is further used to identify the video block subscriptions.

17. A method of operating a multi-projector image rendering system as claimed in claim 1 wherein:
the image processor comprises a video stream processing component and a video display component; and
the video stream processing component, the video display component, or both, are used to blend overlapping portions of the video block subscriptions in the rendered image.

18. A method of operating a multi-projector image rendering system as claimed in claim 1 wherein:
the image processor comprises a video stream processing component and a video display component; and
the video stream processing component, the video display component, or both, are used to manipulate image data carried by the video block subscriptions to alter the rendered image.

19. A method of operating a multi-projector image rendering system as claimed in claim 1 wherein:
the image processor comprises a video stream processing component and a video display component; and
the video stream processing component and the video display component communicate to synchronize projection of the video block subscriptions in the rendered image.

20. A multi-projector image rendering system comprising a plurality of image projectors coupled to an image processor comprising a video stream processing component and a video display component, wherein the image processor is programmed to:
convert an input video stream into a sequence of relatively static images;
decompose the relatively static images into respective sets of sub-images, wherein the resolution of each sub-image is lower than the resolution of each static image and the sub-image sets collectively represent the input video stream;
convert the decomposed sub-images to sub-image video blocks representing respective spatial regions of the input video stream;
identify video block subscriptions for each of the image projectors; and
operate the image projectors to project image data corresponding to the identified video block subscriptions such that the image projectors collectively render a multi-projector image representing to the input video stream.
